(19) United States
(12) Patent Application Publication
(10) Pub. No.: US 2014/0311306 A1
(43) Pub. Date: Oct. 23, 2014

(54) HAIR CUTTING DEVICE WITH IMPROVED CUTTING MEMBER

(71) Applicant: KONINKLIJKE PHILIPS N.V., EINDHOVEN (NL)

(72) Inventor: Siegfried Sablatschan, Ferlach (AT)

(21) Appl. No.: 14/356,752

(22) PCT Filed: Nov. 1, 2012
(86) PCT No.: PCT/IB2012/056085

§ 371 Date: May 7, 2014

Related U.S. Application Data
(60) Provisional application No. 61/556,997, filed on Nov. 8, 2011.

(51) Int. Cl. B26B 19/38

(52) U.S. Cl. CPC B26B 19/3846; B26B 19/3893
USPC 83/13; 30/223; 76/104.1

(57) ABSTRACT

A cutting unit for a hair cutting device, comprising a stationary cutting member, wherein the stationary cutting member comprises a plurality of stationary blade pieces, and a moving cutting member (10), wherein multiple cutting elements (11) are extending along a middle axis (A) from a base sheet (12) of the moving cutting member (10), wherein each cutting element (11) of the moving cutting member (10) comprises a proximal end (14) with a first width (W1) connected to the base sheet (12) and a distal end (16) with a second width (W2) facing away from the base sheet (12), a first flank (18) and a second flank (20) each extending from the proximal end (14) to the distal end (16), wherein the first flank (18) and/or the second flank (20) each comprising a blade edge (22) extending at least partially along the first flank (18) and/or the second flank (20), wherein the second width (W2) of the distal end (16) is larger than the first width (W1) of the proximal end (14). This arrangement allows an improved cut without plucking the hair.

### FIELD OF THE INVENTION

The invention relates to the field of hair cutting devices, and more specially to a moving cutting member of a cutting unit of the hair cutting device.

### BACKGROUND OF THE INVENTION

A hair cutting device is a device for cutting hair. It comprises a cutting unit and driving means for actuating the cutting unit.

Usually the cutting unit consists of two comb-like cutting members. One cutting member is a stationary cutting member, which is in contact with the skin of the user. The other cutting member is a moving cutting member, which is placed adjacent and in contact with the stationary cutting member. The moving cutting member is coupled to the driving means for driving movement relative to the stationary cutting member. The stationary cutting member may comprise rounded tips to avoid injury to the skin.

The driving means may be a pincer-like hand lever, an electric motor with eccentric or an oscillating armature drive. The driving means may be part of a handset and also occur in high-performance devices on joints or flexible shafts.

From every hair cutting device it will be expected, that hair irrespective from quantity, tightness, length, thickness and form will be caught and cut without lifting of the moving cutting member, from the stationary cutting member, while cutting.

The European patent application EP1894685B1A discloses a hair cutting device with a modified moving cutting member in order to improve catching hair. However, the European patent application is based on the quantity of cutting elements for cutting the hair together with blade pieces of the stationary cutting member. In the European patent application the modified moving cutting member uses the double amount of the cutting elements. However, the double amount of cutting elements does not improve the cutting performance of the hair cutting device satisfactorily.

It is known that hair cutting devices for hair have the problem that under heavy load conditions pulling happens. The term heavy load describes a maximum quantity, tightness, length, thickness and form of hair. The pulling is redoubtable, because it could generate pain by plucking hair. Expertise for this effect is known from the application research and from the professionals in hair clipping and pet clipping. To avoid plucking of hair a strong driving mean is provided, which is expensive and voluminous, and a very strong spring is provided, which presses the two cutting plates together. This leads to friction and therefore friction reducing measures are necessary.

### SUMMARY OF THE INVENTION

Therefore, it is an object of this invention to provide a cutting unit, which provides an improved cutting of hair without plucking hair.

This object is achieved by a cutting unit for a hair cutting device, comprising a stationary cutting member, wherein the stationary cutting member comprises a plurality of blade pieces, and a moving cutting member, wherein multiple cutting elements are extending along a middle axis from a base sheet of the moving member, wherein each cutting element of the moving cutting element comprises a proximal end connected to the base sheet with a first width and a distal end with a second width facing away from the base sheet, a first flank and a second flank each extending from the proximal end to the distal end, wherein the first flank and/or the second flank each comprising a blade edge extending at least partially along the first and/or second flank, wherein the second width of the distal end is larger than the first width of the proximal end. The stationary cutting member may comprise a comb like shape, wherein a plurality blade pieces may extrude from a base sheet of the stationary cutting member. The moving cutting member may also comprise a comb-like shape, wherein a plurality of cutting elements is protruding in parallel from a base sheet. The moving cutting member may be placed on the stationary cutting member so that the moving cutting member and the stationary cutting member are in contact with each other. Each cutting element of the moving cutting member comprises a proximal end which is connected with the base sheet and each cutting element comprises a distal end facing away from the base sheet. Furthermore, each cutting element of the moving cutting member comprises a first flank and a second flank each extending from the proximal end to the distal end. Further, the cutting elements of the moving cutting member may be arranged in a same direction in which the stationary blade pieces of the stationary cutting member are arranged. The blade pieces of the stationary cutting member and the cutting elements of the moving cutting member may be arranged in such a way that the blade pieces of the stationary cutting member and the corresponding first flanks and/or the second flanks of the moving cutting member are adjacent to each other. The moving cutting member may be coupled to driving means, for example a manual lever or an electrical motor, for driving movement of the moving cutting member relative to the stationary cutting member, in particular a sideways movement. The moving cutting member may be driven in an oscillating movement, wherein the cutting elements of the moving cutting member are moved towards and over in the movement direction of the adjacent stationary blade pieces of the stationary cutting member. During the movement of the moving cutting member hair may be caught between the gap between the blade pieces of the stationary cutting member and the first flanks and or second flanks of the moving cutting member. The blade edges of the first flanks and/or second flanks of the cutting elements of the moving cutting member may be moved towards the corresponding blade pieces of the stationary cutting member. The hair will be cut when the cutting elements of the moving cutting member are moved over the corresponding blade pieces of the stationary cutting element. Each cutting element of the moving cutting member comprises a first width at the proximal end and a second width at the distal end. The first width at the proximal end of each cutting element of the moving cutting member may be the distance between the protrusion of each cutting element when it protrudes out of the base sheet. The second width of the distal end of each cutting element of the moving cutting member is the width of the distal end. The first flank and/or the second flank may at least comprise partially a blade edge. The blade edge may be directed towards the adjacent stationary blade pieces of the stationary cutting member. The hair will be cut by moving the cutting elements sideways towards the in moving direction adjacent blade pieces.

According to one embodiment the first flank and/or second flank comprise a first section adjacent to the proximal end and a second section adjacent to the first section and the distal end, wherein the first section and/or the second section are at least partially curved. The second width at the distal end may be reduced towards the proximal end until the second section connects to the first section. At the connection point the width of the second section may be reduced to the width of the first section. The reduction of the second width may be achieved by a curve. By providing a curved second section the caught hair may glide along the curve of the first flank and/or second flank towards the first section. Thereby, the hair is cut by an oblique shearing process. By a sickle like shape of the cutting element, the second width at the distal end is able to catch the hair. During the movement of the moving cutting member towards the stationary cutting member the hair are pressed against the blade edge. The hair are gliding and following the curve of the blade edge in the second section and are pushed thereby further towards the middle axis of the cutting element and thereby the hair are cut in an oblique shearing process, which is similar to a cut achieved by a knife. Each cutting element comprises at the distal end a larger width than at the proximal end, wherein, each cutting element may comprise a sickle shape which simplifies the catching of hair.

In a preferred embodiment the first section is formed at least partially essential parallel to the middle axis. This improves the catching of hair by providing a room where the hair may be guided to. The second width of the distal end catches the hair and guides the hair with the help of the reduction of the width of the second section towards the partially essential parallel part of the first section. Since the first section comprises a smaller width than the second width the hair are not able to leave the space between the blade pieces of the stationary cutting member and the first flanks and/or second flanks of the moving cutting member. The larger width of the second width is blocking the way out.

In another preferred embodiment the distal end comprises at least one cutting edge, whereby the at least one cutting edge is facing away from the base sheet. This may additionally improve the cutting performance, since a further cutting area is provided at the distal end. Thereby, hair which may not be caught between the flanks of the cutting elements and the in moving direction of the cutting elements adjacent stationary blade pieces of the stationary cutting member may be cut by the cutting edges, when the cutting member is moved sideways, in particular in an oscillating movement, towards the in moving direction of the cutting members adjacent blade pieces of the stationary cutting member.

According to another embodiment the cutting edge at the distal end is formed V-shaped, in particular in a V-shaped recess. The opening angle of the V-shaped cutting edge may be about 170°. Thereby, the length of the cutting edges may be increased and the cutting performance may be improved. The cutting edge of the distal end may be formed a U-shape like, an oval-shape or a spade-shape. Thereby, the length of the cutting edges may be increased and the cutting performance may be increased.

In a preferred embodiment the cutting edge at the distal end comprises a recess, wherein the recess may extend from an opening of the distal end along the middle axis towards a bottom end of the recess, whereby the opening is a gap at the distal end. The cutting edge may be formed onto the side of the recess. By providing an additional recess the hair may glide along the cutting edge of the recess and then may be caught inside the recess. The hair may be cut by the cutting edge of the recess in an oblique shearing process. Then the recess is moved towards the in moving direction adjacent blade piece of the stationary cutting member the hair is gliding along the cutting edge and the hair may be cut by the cutting edge of the recess. Further, an additional cutting length of the cutting edges may be provided by the recess.

According to another embodiment the bottom end of the recess may comprise a larger width than the opening of the recess at the distal end. Thereby, the catching of the hair of the recess may be improved, since due to the smaller width at the opening the hairs are not able to leave the recess easily before being cut.

In a preferred embodiment, the cutting elements comprise a cross section with a trapezoid shape, a triangle shape or a curved shape. The cutting elements may comprise for example a flat shape, whereby the flat shape may be formed in a rectangular shape, in particular in a trapezoid shape. The trapezoid shape may comprise a long base and a short base, whereby the long base and the short base are parallel to each other. The long base and the short base may be connected to each other by sides, whereby the sides may be the first flank and the second flank. The trapezoid shape may be an orthogonal trapezoid, an isosceles trapezoid, a parallelogram or in particular a symmetrical trapezoid. It may also be possible that the short base of the trapezoid shape may comprise a curved shape, whereby the curved shape may be formed towards in direction of the long base. The blade edges may be arranged at the edge of the connection between the long base and the first flank and/or second flank. Further, in another example the cross section of the cutting element may comprise a triangle shape, in particular an isosceles triangle shape. The base angle of the isosceles triangle may be in particular an angle of about 45°. The blade edges may be arranged at the edge of the connection between the hypotenuse and the first flank and/or second flank. In another example the cross section of the cutting edge may comprise a curved shape, whereby in the curved shape a long tangent angle may be in particular an angle of about 45°. The blade edges may be arranged at the edge of the connection between a chord and a circular arc of the curved shape. By providing cutting elements with a trapezoid, a triangle or a curved cross section the cutting of the cutting device may be improved. The first flanks and or the second flanks may provide a wedge along which the hair may glide in an oblique shearing process. The wedge may comprise a constant wedge angle of about 45°. Thereby, the cutting performance may be increased.

The invention is further related to a production method for producing a moving cutting member for a cutting unit, comprising the steps of: providing a blank of the moving cutting member; widening of the distal end of the cutting elements of the moving cutting member by a cold forming process; grinding of blade edges on the first flanks and/or second flanks of the cutting elements of the moving cutting member. A blank of the moving cutting member may be produced by cutting, sintering, by laser cutting, by die casting, by milling, etc, in particular by coining The blank of the moving cutting member may comprise a comb like shape and the second widths of the cutting elements comprise the same width or a smaller width than the first width. With a progressive die and an integrated straight aligned cold forming process the distal ends of the section may be widened to increase the second width until the second width comprises a larger width than the first width. Further, by the use of a cold forming process for widening the distal end the corrosion resistance of the moving cutting member in particular of the blade edges of the cutting elements, may be improved. Furthermore, it is not necessary to heat up the moving cutting member for a widening process, thereby, the production efficiency may be increased, since it is possible to save energy for heating up, costs for heating up and time for cooling down of the moving cutting member before a further production step. Further, the manufacturing of a constant wedge angle from the distal end to the proximal end may be possible with a low amount of for example about 45°.

According to another embodiment the production method comprises the further steps of providing cutting edges at the distal ends and grinding of the cutting edges. The cutting edges may be produced during the widening of the second section or in a later production process. Thereby, a larger cutting length for cutting hair may be provided. Optionally a surface facing towards the stationary cutting member in an assembled state of the hair cutting device may be flattened, in particularly by grinding.

The invention is further related to a method for cutting hair with a haircutting device with a cutting unit comprising the steps of: catching a plurality of hair between the stationary blade pieces of the stationary cutting member and first flanks and/or second flanks of the cutting elements of the moving cutting member; moving the first flanks and/or the second flanks of the cutting elements of the moving cutting member towards the corresponding stationary blade pieces of the adjacent stationary cutting member; cutting the hair by an oblique shearing process, wherein the hair are gliding along the blade edges of the first flanks and/or second flanks by following the first flanks and/or second flanks of the moving cutting member. The hair are caught for example by a sickle shaped second section, when the first flanks and/or the second flanks of the cutting elements of the moving cutting member are moving towards the in moving direction adjacent stationary blade edges of stationary cutting member. The moving cutting member may be coupled to driving means, for example a manual lever or an electrical motor, for driving movement of the moving cutting member relative to the stationary cutting member, in particular a sideways movement. The moving cutting member may be driven in an oscillating movement. Thereby the cutting elements of the moving cutting member are moved towards and are moved over the in moving direction adjacent stationary blade pieces of the stationary cutting member. Thereby, the hair will be cut in an oblique shearing process. By a sickle like shape of the cutting element, the second width at the distal end is able to catch the hair. During the movement of the moving cutting member towards the stationary cutting member the hair are pressed against the blade edge. The hair are gliding and following the curve of the blade edge in the second Section and are pushed thereby further towards the middle axis of the cutting element and thereby the hair are cut by an oblique shearing process, which is similar to a cut achieved by a knife.

According to another embodiment the method for cutting hair comprises the further steps of cutting hair with the cutting edges of the distal ends of the cutting elements of the moving cutting member. Thereby, the hair will be cut in an oblique shearing process. The hairs are caught by the cutting edges of the distal ends. The hair glide along the cutting edges of the distal ends, when the cutting elements are moved towards the in movement direction adjacent stationary blade pieces of the stationary cutting member. Thereby, the cutting performance may be improved, since the cutting edges provide an additional cutting length.

### BRIEF DESCRIPTION OF THE DRAWINGS

These and other aspects of the invention will be apparent from and elucidated with reference to the embodiments described hereinafter.

In the drawings:

FIG. 1 shows a detailed view of two cutting elements of the moving cutting member;

FIG. 2 shows an illustration in which the oblique shearing process is described;

FIG. 3 shows a detailed view of two cutting elements of the moving cutting element according to another embodiment of the invention;

FIG. 4 shows a detailed view of a cutting element of the moving cutting element according to another embodiment of the invention;

FIGS. 5a to 5d show different simplified detailed views of a cross section of a cutting line C-C in FIG. 1.

### DETAILED DESCRIPTION OF EMBODIMENTS

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

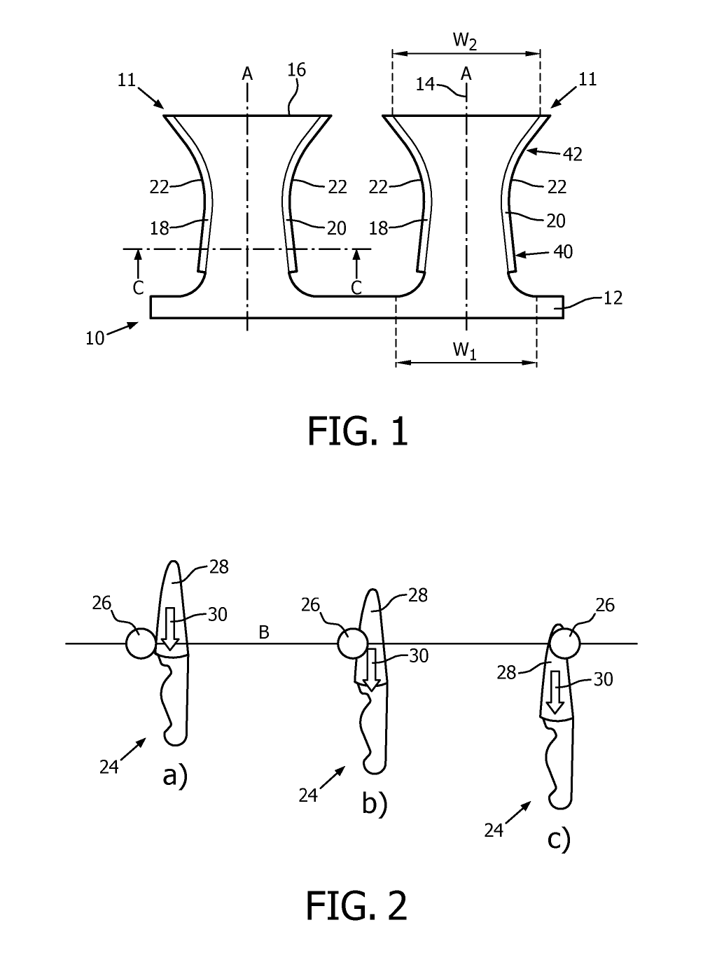

FIG. 1 is showing a detailed view of two cutting elements 11 of a moving cutting member 10 of a cutting unit (not shown) of a hair cutting device (not shown). The moving cutting member 10 comprises a comb-like shape, wherein multiple cutting elements 11 are protruding from a base sheet 12. Each cutting element 11 comprises a proximal end 14, which is connected to the base sheet 12. At the opposite side of the proximal end 14 of the cutting element 11 is a distal end 16, which is facing away from the base sheet 12. As shown in FIG. 1 the distal end 16 comprises a second width W2 which is a larger width than a first width W1 of the proximal end 14. The first width W1 at the proximal end 14 of each cutting element 11 of the moving cutting member comprises the distance between the protrusion of each cutting element 11 when it protrudes out of the base sheet 12. The second width W2 of the distal end 16 of each cutting element of the moving cutting member is the width of the distal end 16. The second width W2 of the distal end 16 may be produced by a cold forming process. The cutting element 11 comprises a first flank 18 and a second flank 20. The first flank 18 and the second flank 20 are extending from the proximal end 14 towards the distal end 16. Further, the first flank 18 and the second flank 20 comprise each at least partially a blade edge 22 formed thereon, so the cutting element 10 is able to cut hair. The cutting element 11 comprises a first section 40, which is adjacent to the proximal end 14, and a second section 42, which is adjacent to the first section 40 and the distal end 16. Furthermore, the first section 40 and the second section 42 are at least partially curved. The first flank 18 and the second flank 20 comprise a radius at the connection of the proximal end 14 with the base sheet 12.

The first flank 18 and the second flank 20 of the first section 40 are starting from the proximal end 14 partially essential parallel to a middle axis A. At the connection between the first section 40 and the second section 42 the width go over to be inclined to the middle axis A until the first flank 18 and the second flank 20 are connected to the distal end 16. As shown in FIG. 1 the first flank 18 and the second flank 20 of the second Section 42 are going over to be inclined to the middle axis with a curve.

By providing the second width W2 at the distal end 16 a distance between the distal end 16 and the connection between the first section Si and the second section S2 is provided with a sickle like shape. This improves the catching of hair during the hair cutting process. Further, by providing a curve at the first flank 18 and the second flank 20 at the second section 42 a homogeneously motion of the hair along the curve of the blade edge 22 may be achieved. When the hairs are moved towards the stationary cutting member (not shown) by the moving cutting member the hair will be cut with an oblique shearing process. The main principle is to catch hair by many sickles. The so caught hair do not leave the cutting area and so the efficiency of cutting hair may be improved over cutting members with common cutting elements of a common hair cutting devices. This oblique shearing process may be explained by the way a hair 26 may be cut with a straight blade 28, for example a knife 24.

FIG. 2 shows an illustration of a principle of an oblique cutting with a knife 24. It is possible to cut an object 26 with a relative movement of the knife 24. The object 26 is cut without a shear movement transverse to a longitudinal extension of the object 26, whereby the object 26 may be moved slightly in longitudinal extension. In FIG. 2a the object 26 is fixed, for example by a hand of a user (not shown), in the horizontal plane B in which the object 26 is arranged essentially with its longitudinal extension. A blade 28 of a knife 24 is pressed onto the object 26 and the knife 24 is pulled down in direction of an arrow 30. In FIG. 2b it may be seen that the object 26 is still fixed in the horizontal plane B and is not moved. The knife 24 is moved in direction of the arrow 30 and half of the blade 28 has already cut through the half of the object 26. In FIG. 2c the object 26 is still fixed in plane B and the blade 28 of the knife 24 has cut through the object 26. This principle may be transferred onto to one embodiment of the cutting element of the invention. By the sickle like shape of the cutting element 11, the second width W2 at the distal end 16 is able to catch the hair. During the movement of the cutting element of the moving cutting member towards the in movement direction of the cutting element adjacent stationary blade piece of the stationary cutting member the hair are pressed against the blade edge 22. The hair are gliding and following the curve of the blade edge 22 in the second Section 42 and are pushed thereby further towards the middle axis A of the cutting element 11 and thereby a cut of a drawing knife 24 is created.

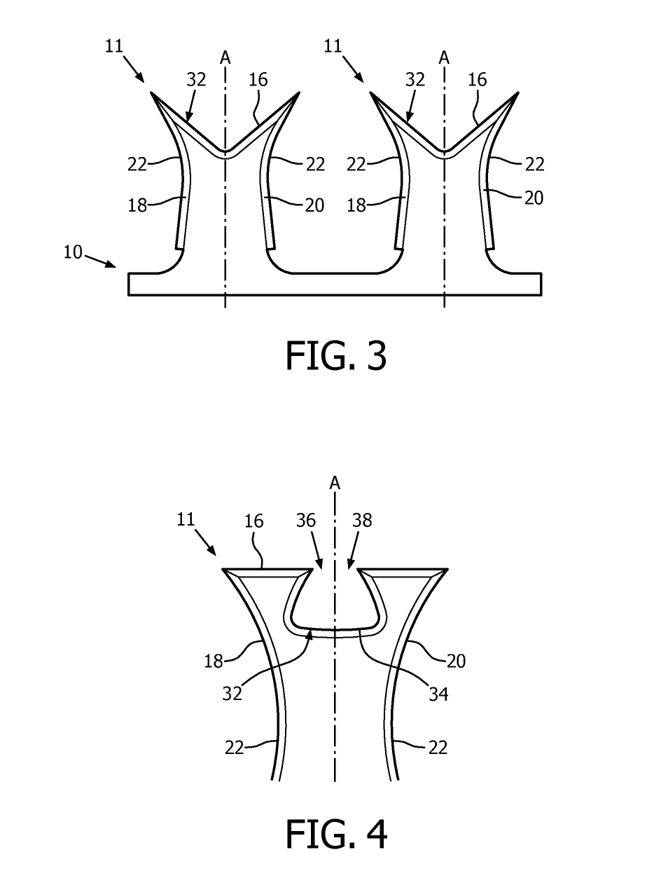

FIG. 3 shows a further embodiment of the invention. The cutting element 11 comprises a cutting edge 32 formed as a recess at the distal end 16. The cutting edge 32 in FIG. 3 is formed V-shaped. By providing a cutting edge 32 at the distal end 16 it is possible to improve further the efficiency of the cutting process and thus reduce the risk of pulling.

FIG. 4 shows another example of a cutting edge 32 at the distal end 16 of the cutting element 11. The cutting edge 32 is a recess 36 and comprises at a bottom end 34 a larger width than the opening 36. By providing a smaller width of the recess 36 at the opening 38 it is possible to provide a further improvement of efficiency, since the hair may be caught with the sickle like opening 38 and then glide down along the cutting edge 32 towards the bottom end 34.

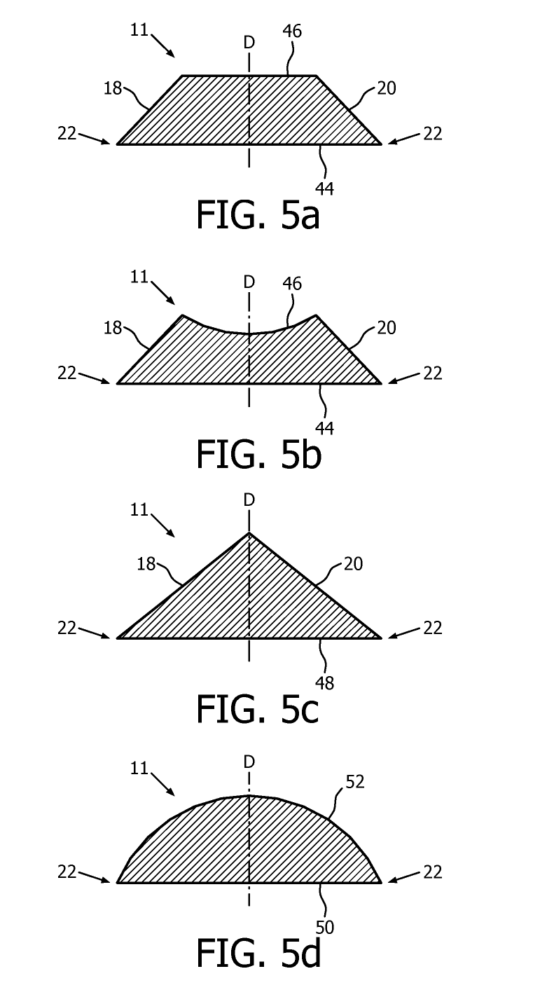

FIGS. 5a to 5d show cross sections of a cutting element 11 of FIG. 1. The cutting element 11 in FIG. 1 has been cut along the cutting line C-C. The detailed views in FIGS. 5a to 5d are simplified and only show the cross section of the first section 40 of the cutting element 11, which has the same shape as the cutting element 16 of a blank(not shown) of the cutting member 12 before a distal end 16 of the cutting element 16 is widened. Further, blade edges 22 may be grinded onto the first flank 18 and/or second flank 20.

In FIG. 5a, the cross section of the cutting element 11 comprises a trapezoid shape, in particular in a symmetrical trapezoid shape. The cutting element 11 comprises a long base 44 and a short base 46 which are parallel to each other. The long base 44 and the short base 46 are spaced from each other along the middle axis D. The trapezoid shape cutting element 11 comprises sides which are connecting the long base 44 to the short base 46. The sides are a first flank 18 and a second flank 20 of the cutting element 11. The cutting element 11 may comprise blade edges 22, which may be arranged at the connection between the long base and the first flank 18 and/or second flank 22.

In FIG. 5b cross section of the cutting element 11 comprises a trapezoid shape, in particular in a symmetrical trapezoid shape. The cutting element 11 comprises a long base 44 and a short base 46 which are parallel to each other. The long base 44 and the short base 46 are spaced from each other along the middle axis D. The trapezoid shape cutting element 11 comprises sides which are connecting the long base 44 to the short base 46. The sides are a first flank 18 and a second flank 20 of the cutting element 11. Further, the short base 46 comprises a curved shape which is directed toward the long base 44. The cutting element 11 may comprise blade edges 22, which may be arranged at the connection between the long base and the first flank 18 and/or second flank 22.

In FIG. 5c cross section of the cutting element comprises a triangle shape, in particular an isosceles triangle shape, where by a hypotenuse 48 may be longer than two cathetuses. The two cathetuses are a first flank 18 and a second flank 20 of the cutting element 11. The isosceles triangle shape of the cross section of the cutting element 11 may comprise in particular a base angle of about 45°. The cutting element 11 may comprise blade edges 22, which may be arranged at the connection between the hypotenuse and the first flank 18 and/or second flank 22.

In FIG. 5d the cross section of the cutting element 11 comprises a curved shape, whereby in the curved shape of the cross section of the cutting element 11 a long tangent angle may be in particular an angle of about 45°. The cutting element 11 may comprise blade edges 22 which may be arranged at the edge of the connection between a chord 50 and a circular arc 52 of the curved shape of the cutting element 11.

By providing cutting elements 11 with a trapezoid, a triangle or a curved cross section the cutting of the cutting device will be improved. The first flanks 18 and/or the second flanks 20 may provide a wedge along which the hair may glide in an oblique shearing process, whereby the wedge may comprise a wedge angle of about 45°. Thereby, the cutting performance may be increased.

### REFERENCE SYMBOL LIST

10 moving cutting member
11 cutting element
12 base sheet
14 proximal end
16 distal end
18 first flank
20 second flank
22 blade edge
24 knife
26 object
28 blade
30 arrow
32 cutting edge
34 bottom end
36 recess
38 opening
40 first section
42 second section
44 long base
46 short base
48 hypotenuse
50 chord
52 circular arc
A middle axis
B horizontal plane
C cutting line
D middle axis
W1 first width
W2 second width

1. A cutting unit for a hair cutting device, comprising
a stationary cutting member, wherein the stationary cutting member comprises a plurality of stationary blade pieces, and
a moving cutting member, wherein multiple cutting elements are extending along a middle axis (A) from a base sheet of the moving cutting member,
wherein each cutting element of the moving cutting member comprises a proximal end with a first width (W1) connected to the base sheet and a distal end with a second width (W2) facing away from the base sheet,
a first flank (18) and a second flank each extending from the proximal end to the distal end,
wherein the first flank and/or the second flank each comprising a blade edged extending at least partially along the first flank and/or the second flank,
wherein the second width (W2) of the distal end is larger than the first width (W1) of the proximal end,
wherein the distal end comprises at least one cutting edge, wherein the at least one cutting edge is facing away from the base sheet, and
wherein the at least one cutting edge is formed as a recess at the distal end.

2. The cutting unit according to claim 1, wherein the first flank and/or second flank comprise a first section adjacent to the proximal end and a second section adjacent to the first section and the distal end, wherein each of the first sections and/or the second sections are at least partially curved.

3. The cutting unit according to claim 2, wherein the first section is formed at least partially essential parallel to the middle axis (A).

4. (canceled)

5. The cutting units according to claim 1, wherein the cutting edge at the distal end is formed in a V-shape.

6. The cutting unit according to claim 1, wherein the cutting edge at the distal end comprises a recess, wherein the recess extends from an opening of the distal end (16) along the middle axis (A) towards a bottom end of the recess.

7. The cutting unit according to claim 5, wherein the cutting edge comprises at the bottom end of the recess a larger width than the opening of the recess at the distal end.

8. The cutting unit according to claim 1, wherein the cutting elements comprise a cross-section with a trapezoid shape, a triangle shape or a curved shape.

9. A production method for producing a moving cutting member for a cutting unit according to claim 1, comprising the steps of:
providing a blank of the moving cutting member, wherein multiple cutting elements are extending along a middle axis (A) from a base sheet of the moving cutting member, wherein each cutting element of the moving cutting member comprises a proximal end connected to the base sheet and a distal end facing away from the base sheet;
widening of the distal end of the cutting elements of the moving cutting member by a cold forming process, such that a second width (W2) of the distal end is larger than a first width (W1) of the proximal end; and
grinding of blade edges on the first flank and/or second flanks of the cutting elements of the moving cutting member.

10. The production method of claim 9, further comprising the steps of providing cutting edges at the distal ends, grinding of the cutting edges.

11. A use of with a haircutting device with a cutting unit according to claim 1 for cutting hair, comprising the steps of:
catching a plurality of hairs between the stationary blade pieces of the stationary cutting member and first flanks and/or second flanks of the cutting elements of the moving cutting member;
moving the first flanks and/or the second flanks of the cutting elements of the moving cutting member towards the corresponding stationary blade pieces of the adjacent stationary cutting member;
cutting the hairs by an oblique shearing process,
wherein the hairs are gliding along the blade edges of the first flanks and/or second flanks by following the first flanks and/or second flanks of the moving cutting member.

12. The use according to claim 11, further comprising the step of cutting hair with the cutting edges of the distal ends of the cutting elements of the moving cutting member.
